(19) United States
(12) Patent Application Publication
(10) Pub. No.: US 2006/0214577 A1
(43) Pub. Date: Sep. 28, 2006

(54) Depositing of powdered luminescent material onto substrate of electroluminescent lamp

(76) Inventors: Lorraine Byrne, Dublin (IE); Philip Keenan, Griffeen (IE); Anna Fenelon, Maynooth (IE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/089,968

(22) Filed: Mar. 26, 2005

(51) Int. Cl. H05B 33/00

(52) U.S. Cl. 313/512

(57) ABSTRACT

A layer of a material is deposited onto a substrate of an electroluminescent lamp in accordance with a desired image. An action is performed to the material to render the material at least partially tacky. Electroluminescent powder is deposited onto the substrate. The electroluminescent powder adheres to the substrate where the material has been deposited thereon.

### BACKGROUND

An electroluminescent lamp (EL) includes a layer of electroluminescent phosphor powder and a dielectric sandwiched between two electrodes. At least one of these electrodes is transparent. On application of a voltage, the electroluminescent phosphor emits light. The electroluminescent phosphor layer may be patterned in the form of a desired image, such as a corporate logo, so that when the EL lamp is turned on, illumination occurs in the form of the desired image. Typically, patterning the luminescent material in the form of a desired image is accomplished by a screen-printing process. However, the screen-printing process is cost effective only for large production runs of a given image. That is, where just a small number of EL lamps are desired to be made with a given image, the screen-printing process can be cost prohibitive.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a flowchart of a method for affixing electroluminescent powder to a substrate of an electroluminescent (EL) lamp, according to an embodiment of the invention.

FIG. 2 is a diagram of a substrate of an EL lamp on which a material has been inkjet-printed thereon in accordance with a desired image, according to an embodiment of the invention.

FIG. 3 is a diagram of a substrate of an EL lamp on which electroluminescent powder has adhered to the substrate substantially where a material has been inkjet-printed on the substrate in accordance with a desired image, according to an embodiment of the invention.

FIG. 4 is a diagram illustratively depicting the method of FIG. 1 for affixing electroluminescent powder to a substrate of an EL lamp, according to an embodiment of the invention.

FIG. 5 is a diagram of an EL lamp, according to an embodiment of the invention.

FIG. 6 is a flowchart of a method for fabricating an EL lamp, according to an embodiment of the invention.

FIG. 7 is a flowchart of a method of use of an EL lamp, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

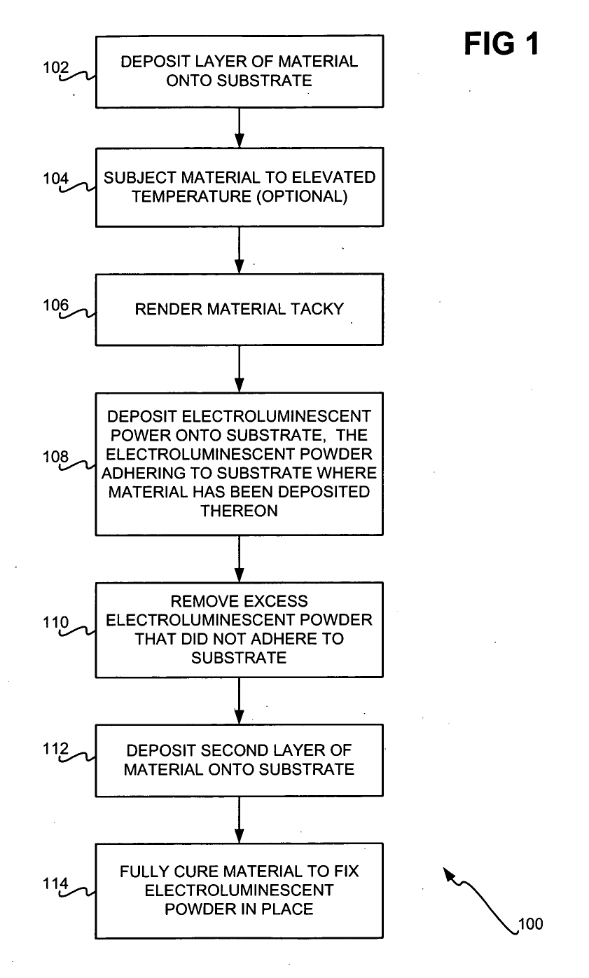

FIG. 1 shows a method 100 for affixing electroluminescent powder to the substrate of an electroluminescent (EL) lamp in accordance with a desired image, according to an embodiment of the invention. The method 100 is a part of an overall process to manufacture an EL lamp, and is specifically concerned with the formation of a luminescent material layer of the EL lamp. The luminescent material may be an inorganic or organic powdered phosphor.

A material is inkjet-printed or otherwise deposited onto a substrate of the EL lamp in accordance with a desired image (102). The material as inkjet printed is not substantially tacky, sticky, or otherwise adhesive. The material may also be deposited onto the substrate in ways other than inkjet-printing, such as via screen-printing or other conventional or novel techniques. The material may be a mixture, a solution, or another type of material. In one embodiment, the material includes a solvent in which one or more ultraviolet light-curable monomers and a photoiniator has been dissolved. For example, the solvent may be an alcohol such as methanol, ethanol, or propanol, the ultraviolet light-curable monomers may be hydroxyl ethylmethacrylate (HEMA) and glycerol dimethacrylate (GDMA), and the photoiniator may be benzoin methyl ether (BME), where the ratio of alcohol to HEMA to GDMA to BME is 30:50:15:5. In another embodiment, the solvent may be an alcohol such as methanol, ethanol, or propanol, the ultraviolet light-curable monomers may be HEMA and GDMA, and the photoiniator may be 2-hydroxy-2-methyl propiophenone (HMP), where the ratio of alcohol to HEMA to GDMA to HMP is 45:20:20:15. In another embodiment, the material can include a colloidal suspension of a polymer resin, such as polyurethane or cellulose, in a solvent. The following additives may also be included in the inkjet printed material: plasticizers, such as adipate or phthalate esters; adhesion promoters, such as silane coupling agents; and, humectants, such as 2-pyrollidinone.

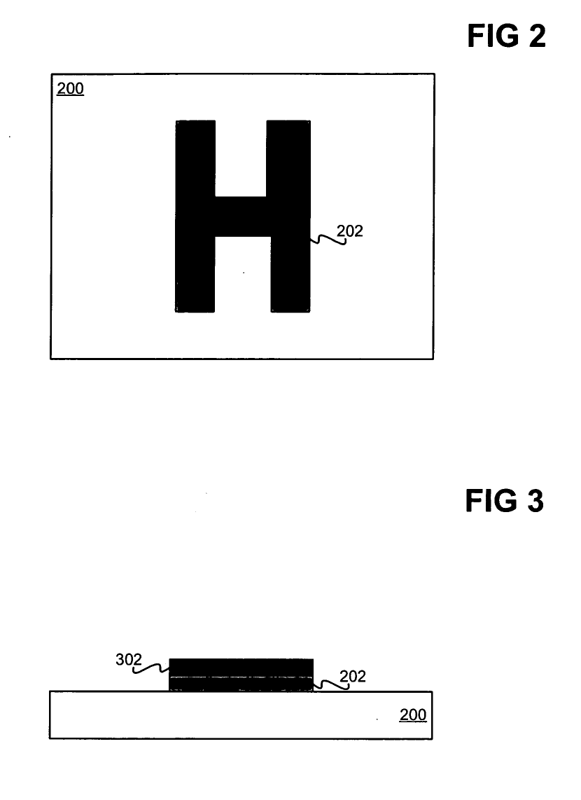

FIG. 2 shows an example of the inkjet-printing of a material onto the substrate of an EL lamp in accordance with a desired image, according to an embodiment of the invention. A layer of material 202 has been inkjet-printed on the substrate 200 of an EL lamp. The material 202 has specifically been inkjet-printed onto the substrate 200 in the form of the letter H as the desired image. As can be appreciated by those of ordinary skill within the art, the desired image in accordance with which the material 202 is inkjet-printed onto the substrate 200 is not limited to a particular form, pattern, or image. The material 202 is in one embodiment a liquid, such that inkjet-printing thereof is accomplished using a standard inkjet-printing mechanism typically employed for ejecting ink onto paper or other media, with minor or no modification. Inkjet-printing as used herein can encompass both drop-on-demand and continuous inkjet-printing techniques, as can be appreciated by those of ordinary skill within the art.

Referring back to FIG. 1, the material may be optionally subjected to a elevated temperature (104), such as approximately 100° C. for approximately thirty seconds, to remove or evaporate some of the solvent, such as alcohol, in the embodiment where the material contains such a solvent. The material is then exposed to an energy source such as UV light or heat for approximately thirty seconds to partially cure the monomers, thereby rendering it tacky (106). In the embodiment where the material includes one or more ultraviolet light-curable monomers and a photoiniator, exposure of the material to the ultraviolet light causes the photoiniator to become excited, to begin the crosslinking reactions between the monomers. The monomers are generally partially cured, however, so that they become adhesive, tacky, or sticky. That is, the ultraviolet light is removed from the material before the monomers become fully cured.

The partial curing performed in 106 is one type of action that is performed to render the material inkjet-printed on the substrate at least partially tacky. Thus, this action may include exposure of the material to ultraviolet or another type of light to partially cure the material. In another embodiment, the material may be subjected to an elevated temperature to render it tacky (i.e., thermal activation), or the material may be chemically activated to render it tacky. Embodiments of the invention are not restricted by the type of action that is to be performed to render the material that was inkjet-printed on the substrate in a non-tacky state into a tacky state.

Next, a electroluminescent powder is deposited onto the substrate (108). Deposition of the electroluminescent powder may be accomplished by spraying the electroluminescent powder onto the substrate as the substrate passes relative to a spray gun, by releasing the electroluminescent powder from a vibratory hopper as the substrate passes underneath the hopper, or by another approach. The electroluminescent powder adheres to the substrate substantially where the material has been previously inkjet-printed or otherwise deposited on the substrate. Thereafter, excess electroluminescent powder that has not adhered to the substrate is removed (110). For instance, vibration, brushing, airflow, vacuum, or another approach may be used to remove excess electroluminescent powder.

FIG. 3 shows an example of the electroluminescent powder adhering to the substrate of an EL lamp substantially where a material has been previously inkjet-printed on the substrate and rendered tacky, according to an embodiment of the invention. The electroluminescent powder 302 sticks to the substrate 200 where the material 202 has been previously inkjet-printed on the substrate 200 and rendered tacky. Excess of the material 302 that did not adhere to the substrate 200 has already been removed in the example of FIG. 3. Thus, the material 302 adheres to the substrate 200 in the form of the same desired image in accordance with which the material 202 has been inkjet-printed on the substrate 200.

In one embodiment, the inkjet-printing of the material 202 onto the substrate 200 off the EL lamp is accomplished in lieu of inkjet-printing the electroluminescent powder 302 itself directly onto the substrate 200 owing to the characteristics of the electroluminescent powder 302. The size of the electroluminescent powder 302 may be substantially larger than what can be usually ejected using typical inkjet-printing mechanisms. For example, copper-doped zinc sulfide phosphor particles have a particle size range between 5 and 35 microns, which is too large to be reliably dispensed through the nozzles of commercially available inkjet-printing mechanisms. Reducing the size of the phosphor particles may be impractical, since doing so reduces the lifetime of the phosphor, and thus the lighting life of the resulting EL lamp. Furthermore, the viscosity of an ink containing a suspension of phosphor powder particles in the quantity to form a continuous light-emitting layer may be too great to eject from commercially available inkjet-printing mechanisms.

Referring back to FIG. 1, a second layer of material is optionally inkjet-printed or otherwise deposited onto the substrate (112), and the material is fully cured to fix the electroluminescent powder into place (114). Full curing may be accomplished by exposing the material to ultraviolet light for approximately ninety seconds from above and/or from below the substrate. Irradiation from below the substrate may be desirable during the full-curing process because the electroluminescent powder may block the ultraviolet light from reaching the first layer of material that was inkjet-printed if ultraviolet light were otherwise only accomplished from above.

The method 100 that has been described is amenable to the construction of EL lamps in short production runs. Whereas the screen-printing process of patterning a desired image into a luminescent material layer of an EL lamp is an analog process that is cost prohibitive for short production runs, the inkjet-printing process of the method 100 is a digital process that is cost effective even for short production runs. Expensive and complex screens, for instance, do not have to be fabricated to pattern a luminescent material layer of an EL lamp with a desired image in the method 100. Rather, inkjet-printing is accomplished to define a desired image for the luminescent material of the EL lamp. The process is digital because the image is defined digitally, and the inkjet-printing of the image is performed by turning on and off an inkjet-printing mechanism in accordance with the image as the mechanism is moved over the substrate of the EL lamp.

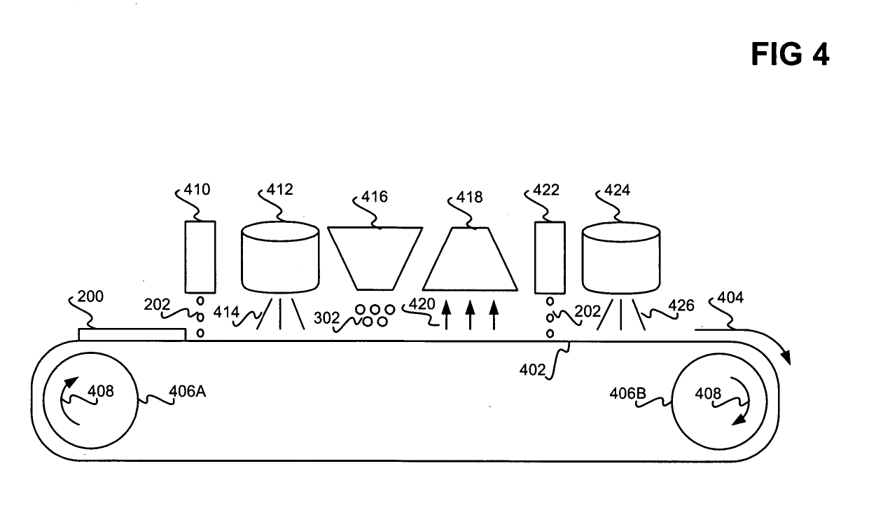

FIG. 4 shows a diagram illustratively depicting performance of the method 100 of FIG. 1, according to an embodiment of the invention. The EL lamp substrate 200 moves from left to right on a conveyor belt 402, as indicated by the arrow 404. Movement of the conveyor belt 402 is accomplished by rotation of rollers 406A and 406B in the direction indicated by the arrows 408. The rollers 406A and 406B are collectively referred to as the rollers 406.

When the substrate 200 passes under the inkjet-printing mechanism 410, the mechanism 410 ejects a first layer of the material 202 in accordance with the desired image. The inkjet-printing mechanism 410 may be or include an inkjet-printing cartridge, one or more inkjet-printing pens, and so on. The substrate 200 then passes under an ultraviolet light source 412 emitting ultraviolet light 414 to partially cure the material 202 to render it at least partially tacky. Thereafter, the substrate 200 passes under a electroluminescent powder release mechanism 416 that releases the electroluminescent powder 302 at least substantially uniformly over the entirety of the substrate 200. The mechanism 416 may be or include a vibratory hopper, a spray gun, or another type of mechanism to release the electroluminescent powder 302 onto the substrate 200.

As the substrate 200 passes under an excess electroluminescent powder removal mechanism 418, the mechanism 418 removes the excess of the electroluminescent powder 302 that did not adhere to the substrate 200, as indicated by the arrows 420. For instance, the mechanism 418 may operate by vacuum, suction, vibration or another approach, such as by ejecting an air stream, and so on. The electroluminescent powder 302 adheres to the substrate 200 where the first layer of the material 202 has been previously inkjet-printed on the substrate 200, as has been described.

A second layer of the material 202 is applied to the substrate 200 in accordance with the desired image by another inkjet-printing mechanism 422, as the substrate 200 passes under the mechanism 422. The substrate 200 finally passes under another ultraviolet light source 424 emitting ultraviolet light 426 to fully cure the material 202, and thus to permanently affix the electroluminescent powder 302 to the substrate 200. As can be appreciated by those of ordinary skill within the art, just one layer of the material 202 may be inkjet-printed on the substrate 200, instead of the two layers depicted in FIG. 4. Furthermore, curing may be accomplished in a manner other than by exposure of the material 202 to ultraviolet light.

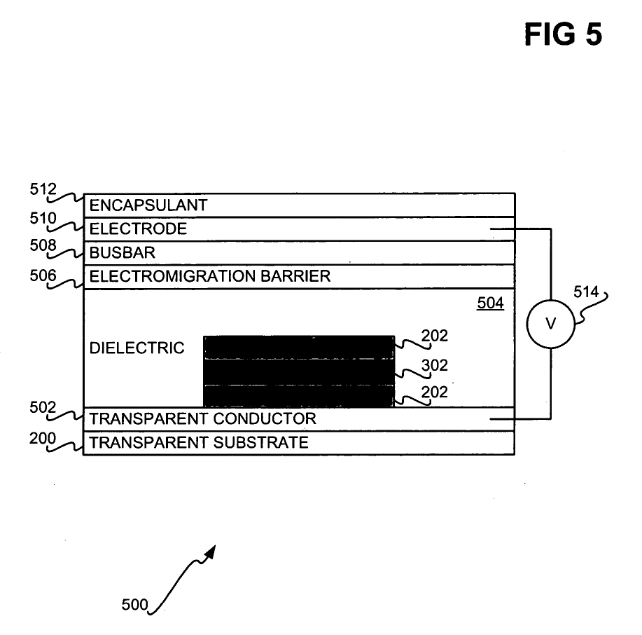

FIG. 5 shows an EL lamp 500, according to an embodiment of the invention. The EL lamp 500 is made up of a number of layers. On top of the transparent substrate 200, which may be polyethylene terephthalate (PET) or another type of substrate, is a transparent conductor 502. The transparent conductor 502 may be indium tin oxide (ITO), or another type of transparent conductor. The electroluminescent powder 302, sandwiched by two layers of the material 202 as has been described, is deposited on the substrate 200 in the embodiment of FIG. 5 over the transparent conductor 502.

Next, a layer of dielectric 504 is deposited over the electroluminescent powder 302 as sandwiched by the layers of the material 202. The dielectric 504 may be barium titanate powder in a polyurethane binder, or another type of dielectric. An electromigration barrier 506, such as carbon, may be fashioned over the dielectric 504 to prevent the electroluminescent powder 302 from migrating through the EL lamp 500 during usage thereof. A busbar 508, such as silver, is deposited directly onto the ITO layer. The function of the busbar is to distribute the electrical power move evenly across the ITO coating. Finally, an electrode 510, which may also be silver, is deposited over the busbar 508, and an encapsulant 512 seals the entire EL lamp 500. The encapsulant 512 may be a fluoropolymer film, such as the clear and/or transparent moisture barrier film sold by Honeywell International Inc. under the trade name Aclar, or any other suitable type of encapsulant.

For usage of the EL lamp 500, a voltage source 514 is applied between the electrode 510 and the transparent conductor 502. Application of power in this manner causes the electroluminescent powder 302 to glow outwards through the transparent conductor 502 and the transparent substrate 200. Because the electroluminescent powder 302 has been formed in the desired image, the image itself illuminates.

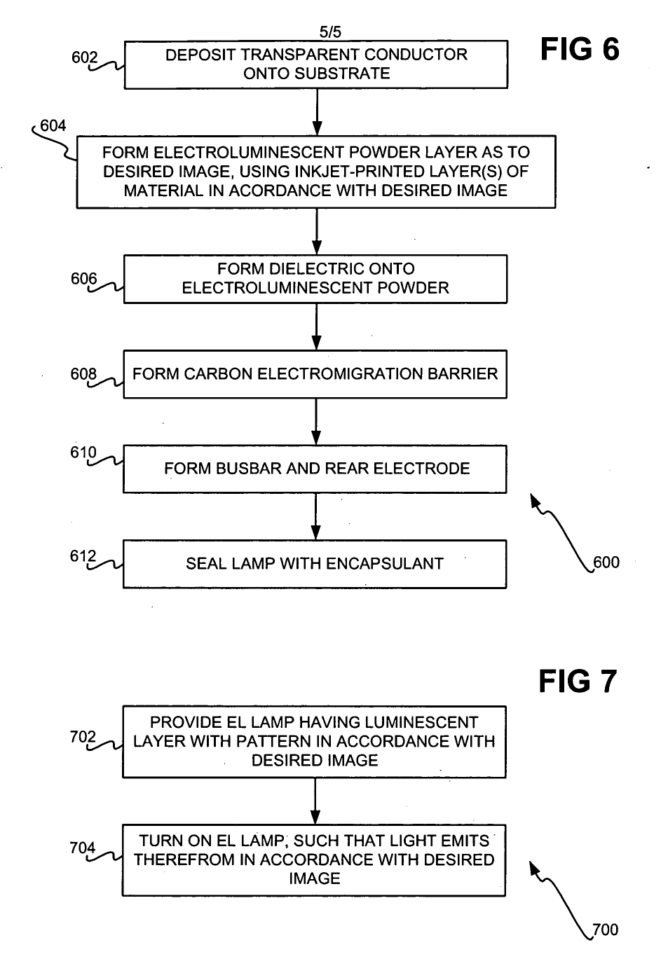

FIG. 6 shows a method 600 for fabricating an EL lamp, according to an embodiment of the invention. A PET polymer substrate, or another type of transparent substrate, is sputtered or otherwise deposited with a layer of ITO, or another type of transparent conductor (602). An electroluminescent powder layer is formed in accordance with a desired image (604). For instance, one or more layers of a material may be inkjet-printed in accordance with a desired image, where the electroluminescent powder adheres to this material, as has been described in relation to FIG. 1.

A dielectric layer is deposited or otherwise formed or created onto the electroluminescent powder (606), and a carbon electromigration barrier is inkjet-printed thereon or otherwise formed or created or deposited (608). A busbar and a rear electrode may also be formed by inkjet-printing, or by another approach to form, create, or deposit the busbar and the rear electrode (610). Finally, the entire lamp is sealed with an encapsulant (612).

FIG. 7 shows a method 700 of use for an EL lamp, according to an embodiment of the invention. An EL lamp is provided that has a luminescent material layer with a pattern in accordance with a desired image (702). The luminescent material layer may be fabricated as has been described in relation to FIG. 1, and the EL lamp itself may be fabricated as has been described in relation to FIG. 6. The EL lamp is turned on (704), such that light emits therefrom in accordance with the desired image.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
depositing a layer of a material onto a substrate of an electroluminescent lamp in accordance with a desired image;
performing an action to the material to render the material at least partially tacky; and,
depositing electroluminescent powder onto the substrate, the electroluminescent powder adhering to the substrate where the material has been deposited thereon.

2. The method of claim 1, wherein depositing the layer of the material comprises inkjet-printing the layer of the material.

3. The method of claim 1, wherein performing the action to the material comprises partially curing the material.

4. The method of claim 3, wherein partially curing the material comprises exposing the material to ultraviolet light.

5. The method of claim 3, wherein partially curing the material comprises exposing the material to an elevated temperature.

6. The method of claim 3, further comprising, before partially curing the material, subjecting the material to an elevated temperature.

7. The method of claim 1, further comprising depositing a second layer of the material onto the substrate in accordance with the desired image.

8. The method of claim 7, further comprising, after depositing the second layer of the material onto the substrate, fully curing the second layer of the material.

9. The method of claim 8, wherein fully curing the second layer of the material comprises exposing the material to ultraviolet light from above the substrate and from below the substrate.

10. The method of claim 1, further comprising, after depositing the electroluminescent powder onto the substrate, removing excess electroluminescent powder from the substrate that did not adhere thereto.

11. The method of claim 1, wherein depositing the electroluminescent powder onto the substrate comprises releasing the electroluminescent powder from a vibratory hopper under which the substrate passes.

12. The method of claim 1, wherein depositing the electroluminescent powder onto the substrate comprises spraying the electroluminescent powder from a spray gun.

13. The method of claim 1, wherein the material comprises:
a solvent;
one or more ultraviolet light-curable monomers dissolved within the solvent; and,
a photoiniator dissolved within the solvent.

14. The method of claim 13, wherein the ultraviolet light-curable monomers are hydroxyl ethylmethacrylate (HEMA) and glycerol dimethacrylate (GDMA), and the photoiniator is benzoin methyl ether (BME).

15. The method of claim 14, wherein the solvent is ethanol, and the ratio of ethanol to HEMA to GDMA to BME is 30:50:15:5.

16. The method of claim 13, wherein the ultraviolet light-curable monomers are hydroxyl ethylmethacrylate (HEMA) and glycerol dimethacrylate (GDMA), and the photoiniator is 2-hydroxy-2-methyl propiophenone (HMP).

17. The method of claim 16, wherein the solvent is ethanol, and ratio of ethanol to HEMA to GDMA to HMP is 45:20:20:15.

18. The method of claim 1, wherein the material contains one or more plasticizers, one or more adhesion promoters, and a humectant.

19. The method of claim 1, wherein the electroluminescent material is powdered phosphor.

20. The method of claim 1, further comprising:
depositing a dielectric layer over the electroluminescent powder;
inkjet-printing a carbon electromigration barrier onto the dielectric;
inkjet-printing a silver busbar and a silver rear electrode onto the carbon electromigration barrier; and,
sealing the lamp with an encapsulant.

21. An electroluminescent lamp formed by performing a method comprising:
inkjet-printing a first layer of a material onto a substrate of the electroluminescent lamp, in accordance with a desired image;
partially curing the material to render the material at least partially tacky;
depositing electroluminescent powder onto the substrate such that the electroluminescent powder substantially adheres to the substrate only where the material has been inkjet-printed thereon;
inkjet-printing a second layer of the material onto the substrate in accordance with the desired image; and,
fully curing the material.

22. The electroluminescent lamp of claim 21, wherein partially curing the material comprises exposing the material to ultraviolet light.

23. The electroluminescent lamp of claim 22, the method further comprising, before exposing the material to ultraviolet light, subjecting the material to an elevated temperature.

24. The electroluminescent lamp of claim 21, the method further comprising, after depositing the electroluminescent powder onto the substrate, removing excess electroluminescent powder that did not adhere to the substrate.

25. The electroluminescent lamp of claim 21, wherein fully curing the material comprises exposing the material to ultraviolet light.

26. The electroluminescent lamp of claim 21, wherein depositing the electroluminescent powder onto the substrate comprises releasing the electroluminescent powder from a vibratory hopper under which the substrate passes.

27. The electroluminescent lamp of claim 21, wherein depositing the electroluminescent powder onto the substrate comprises spraying the electroluminescent powder from a spray gun under which the substrate passes.

28. The electroluminescent lamp of claim 21, wherein the material comprises at least one or more ultraviolet light-curable monomers dissolved within a solvent.

29. The electroluminescent lamp of claim 28, wherein the material further comprises a photoiniator dissolved within the solvent.

30. An electroluminescent lamp comprising:
a substrate;
a curable layer inkjet-printed on the substrate in accordance with a desired image;
an electroluminescent powder layer adhering to the curable layer.

31. The electroluminescent lamp of claim 30, further comprising a second curable layer inkjet-printed over the electroluminescent powder layer in accordance with the desired image.

32. The electroluminescent lamp of claim 30, further comprising:
a transparent substrate coated with a transparent conductor layer;
an electroluminescent powder layer;
a dielectric formed on the luminescent material layer;
a carbon electromigration barrier inkjet-printed on the dielectric;
a silver busbar inkjet-printed on the carbon electromigration barrier;
a silver rear electrode inkjet-printed on the silver busbar; and,
an encapsulant sealing the silver rear electrode.

33. The electroluminescent lamp of claim 30, wherein the curable layer comprises: one or more ultraviolet light-curable monomers, a photoiniator, and a solvent in which the monomers and the photoiniator are dissolved.

34. The electroluminescent lamp of claim 33, wherein the solvent is ethanol, the ultraviolet light-curable monomers are hydroxyl ethylmethacrylate (HEMA) and glycerol dimethacrylate (GDMA), and the photoiniator is benzoin methyl ether (BME).

35. The electroluminescent lamp of claim 33, wherein the solvent is ethanol, the ultraviolet light-curable monomers are hydroxyl ethylmethacrylate (HEMA) and glycerol dimethacrylate (GDMA), and the photoiniator is 2-hydroxy-2-methyl propiophenone (HMP).

36. The electroluminescent lamp of claim 30, wherein the electroluminescent powder is powdered phosphor.

37. An electroluminescent lamp comprising:
a substrate;
a electroluminescent powder layer having a pattern in accordance with a desired image; and,
means for adhering the electroluminescent powder layer to the substrate in accordance with the desired image and applied in at least two layers.

38. The electroluminescent lamp of claim 37, wherein the means for adhering the electroluminescent powder layer comprises a plurality of ultraviolet light-curable monomer layers.

39. A method comprising:
providing an electroluminescent lamp having an electroluminescent luminescent material layer having a pattern in accordance with a desired image and formed by utilizing a plurality of ultraviolet light-curable monomer lights inkjet-printed on a substrate of the electroluminescent lamp in accordance with the desired image; and,
turning on the electroluminescent lamp, such that light emits therefrom in accordance with the desired image of the pattern of the electroluminescent luminescent material layer.
